(19) United States
(12) Patent Application Publication
(10) Pub. No.: US 2002/0167538 A1
(43) Pub. Date: Nov. 14, 2002

(54) Flexible organization of information using multiple hierarchical categories

(76) Inventor: Murthy N. Bhetanabhotla, Sunnyvale, CA (US)

Correspondence Address: MURTHY N. BHETANABHOTLA, P.O. Box 2304, SUNNYVALE, CA, 94087, US

(21) Appl. No.: 09/853,542

(22) Filed: May 11, 2001

(51) Int. Cl. G06F 7/00

(52) U.S. Cl. 345/700

(57) ABSTRACT

The present invention discloses a computer software system for organizing hierarchical information collections that are like virtual file cabinets. These are similar to physical file cabinets, but have more flexibility in arranging and accessing information. Just like in a physical file cabinet, the information items can be categorized and placed sequentially in an order. But, unlike in the physical cabinet where an item can be categorized and placed with reference to only one attribute of the item, the information items stored in virtual file cabinets can be categorized using several attributes like time, location, people and subjects involved. With a single-click of the computer mouse all the information items can be seen sequentially in the appropriate order of any of the attribute types used for categorization, i.e. the virtual file cabinet serves as several file cabinets each one holding the items according to the order of each of the attributes. It is as if the same information item is present in several file cabinets that use different categorization systems.

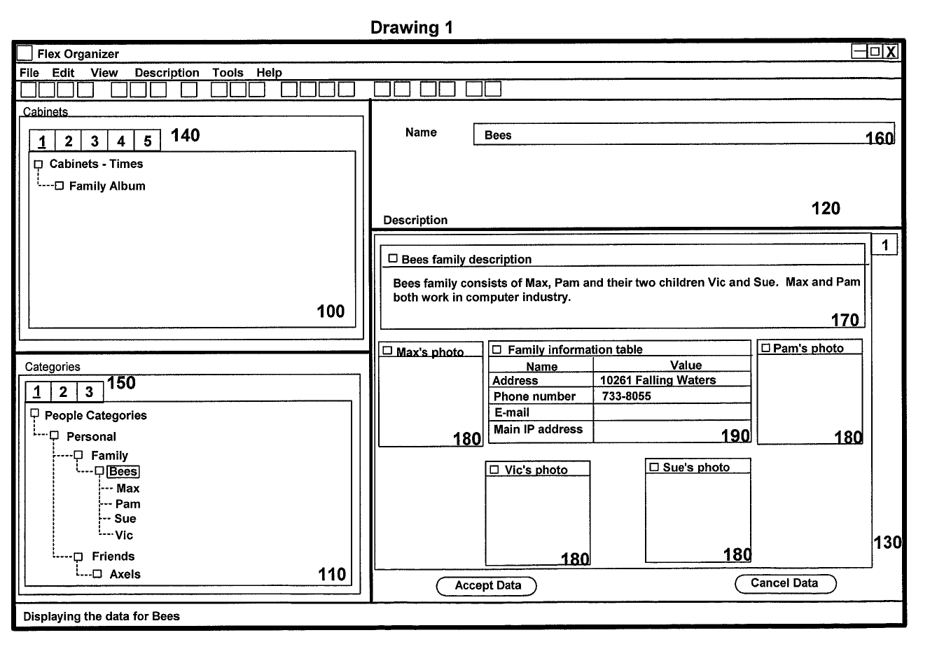

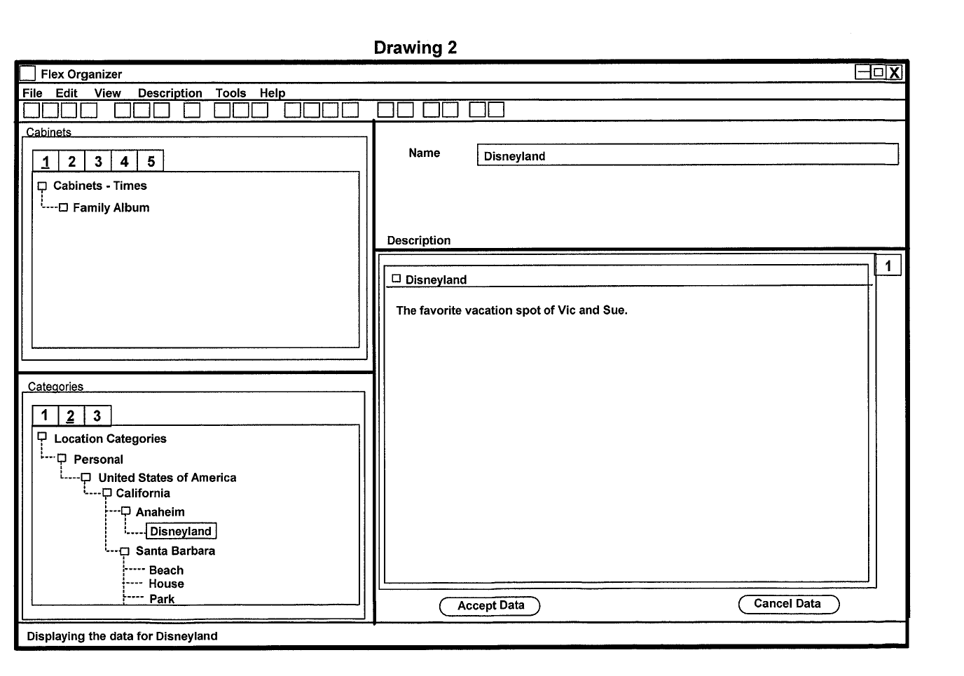

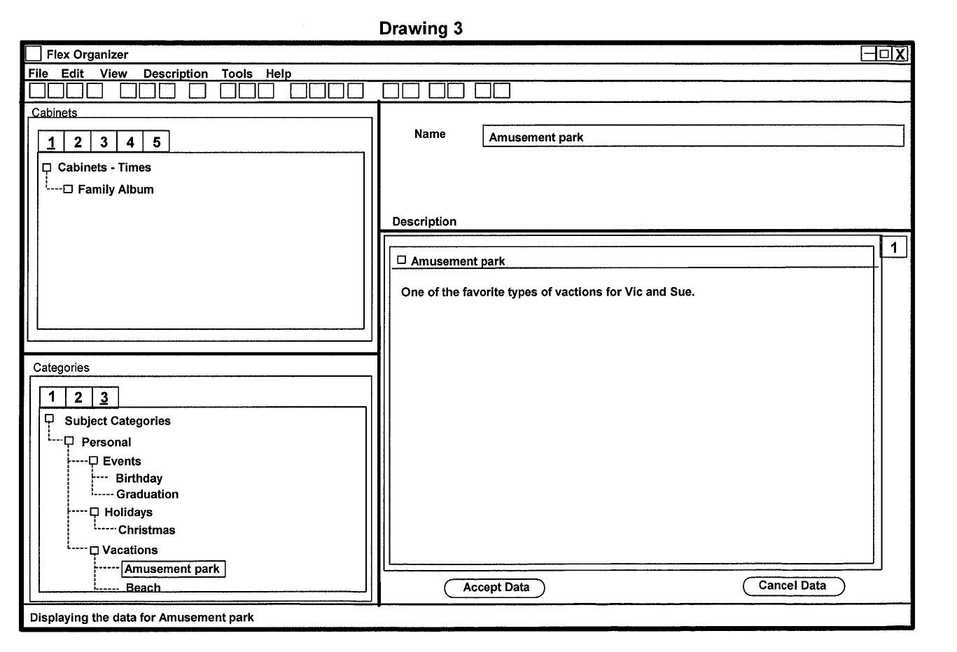

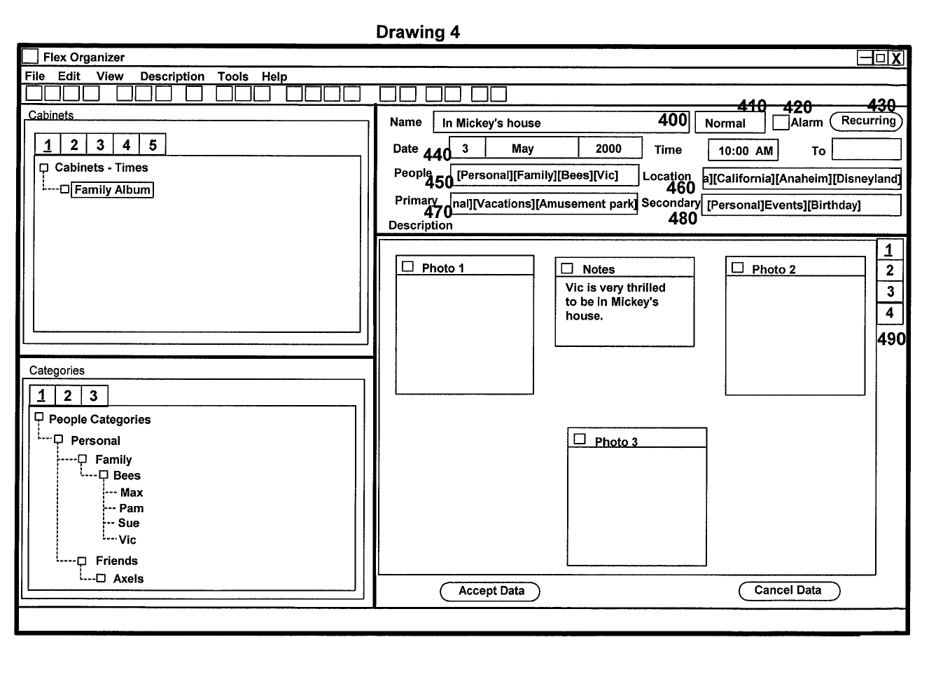

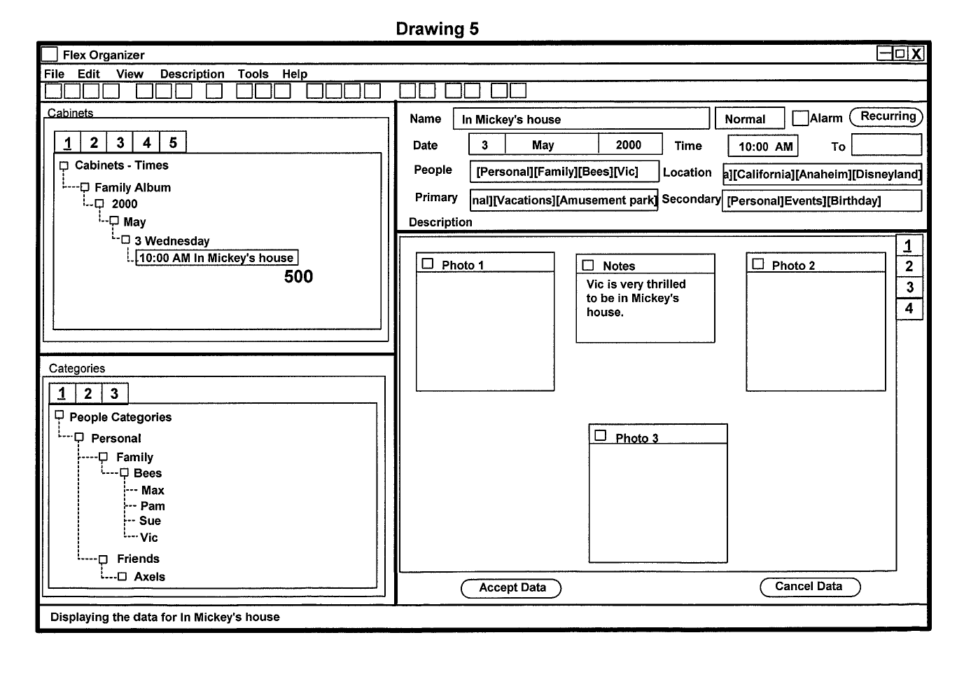

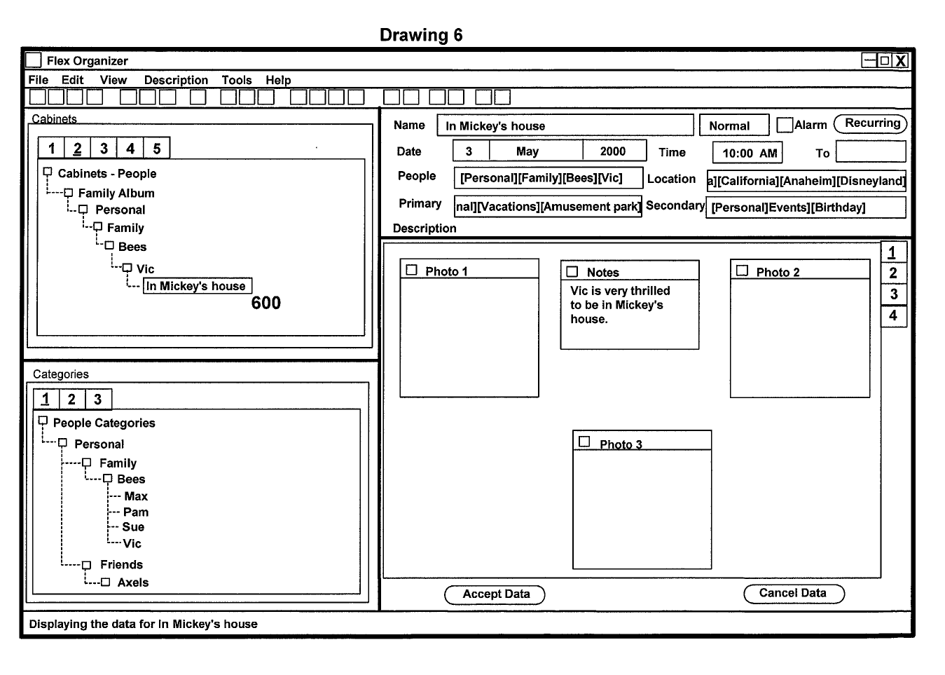

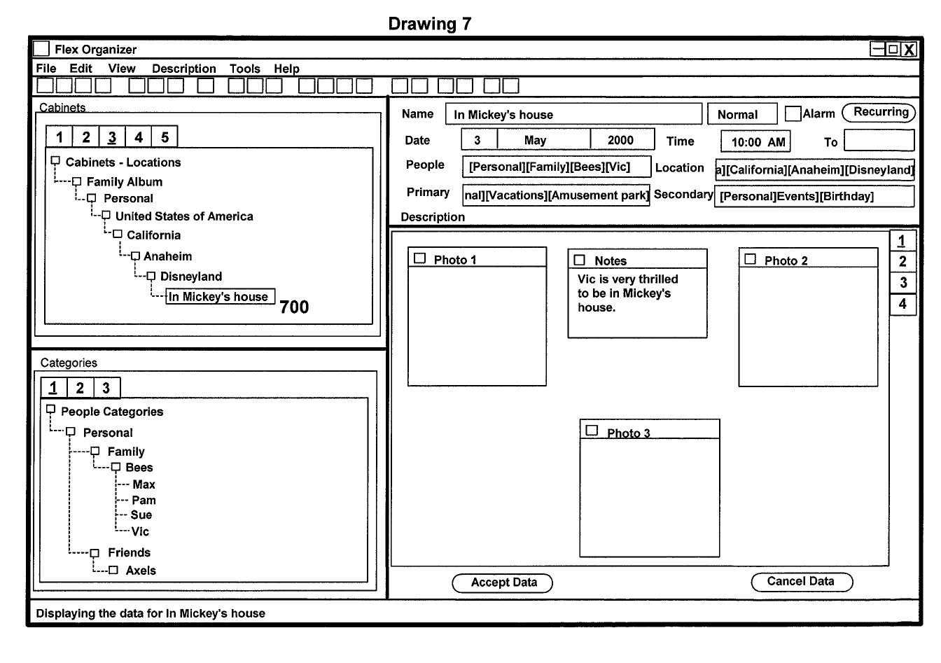

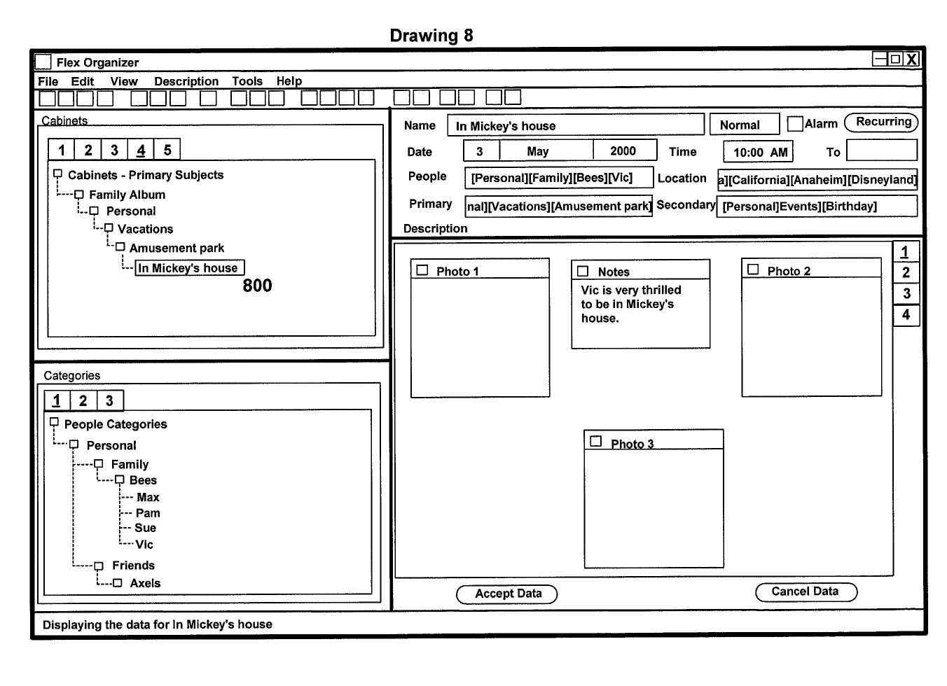

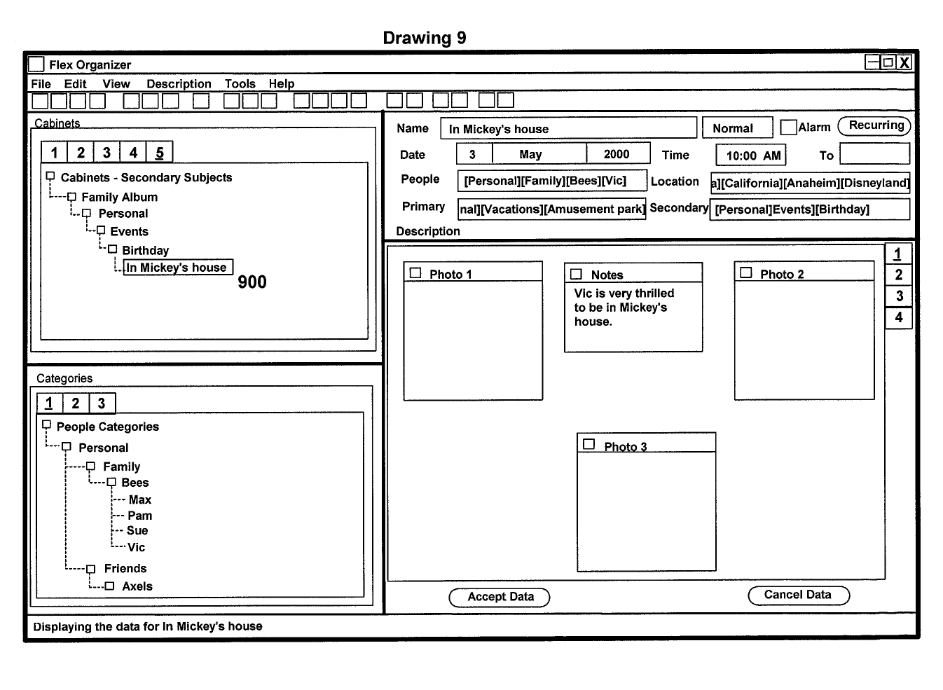

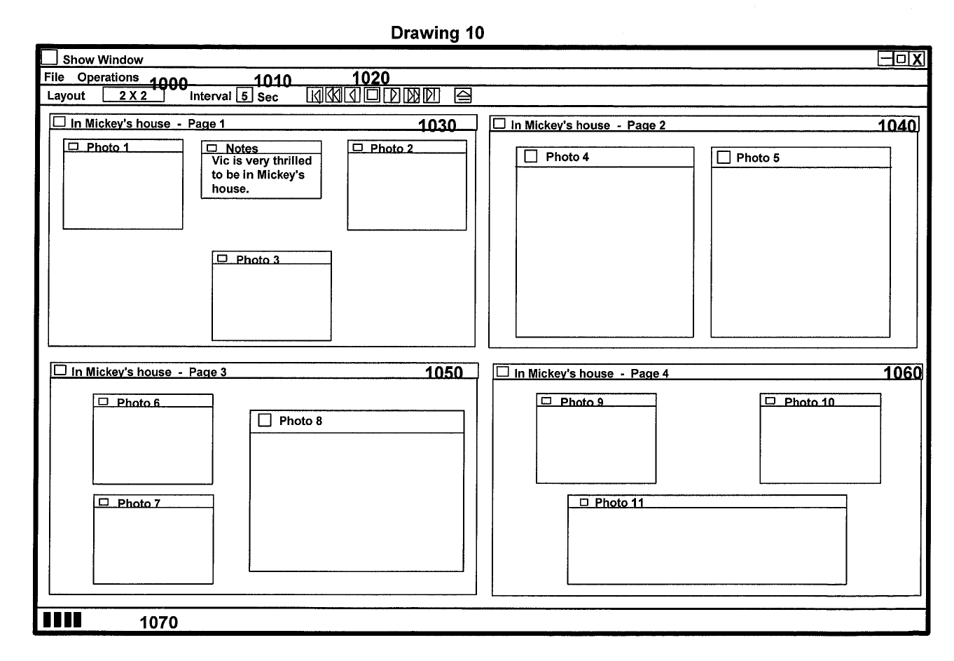

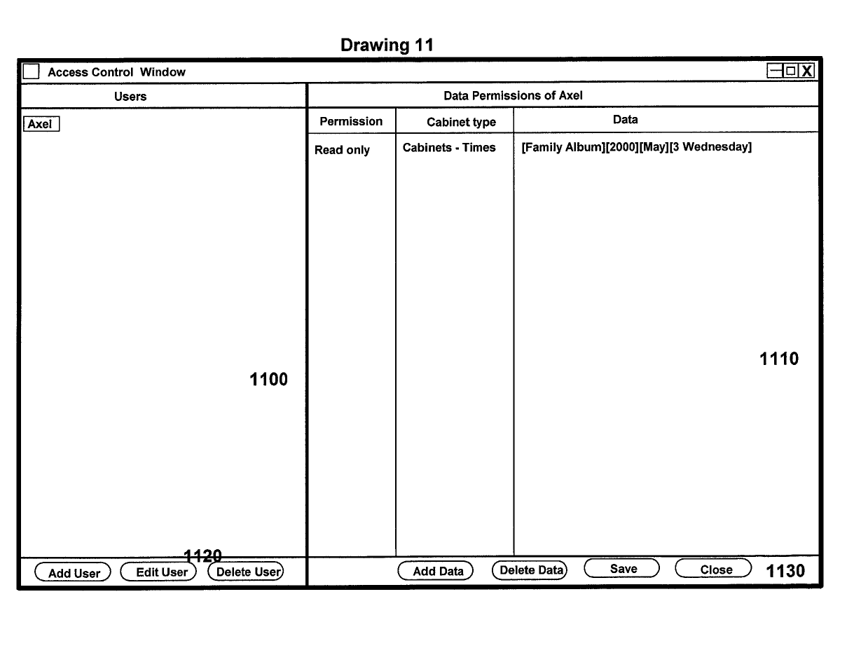

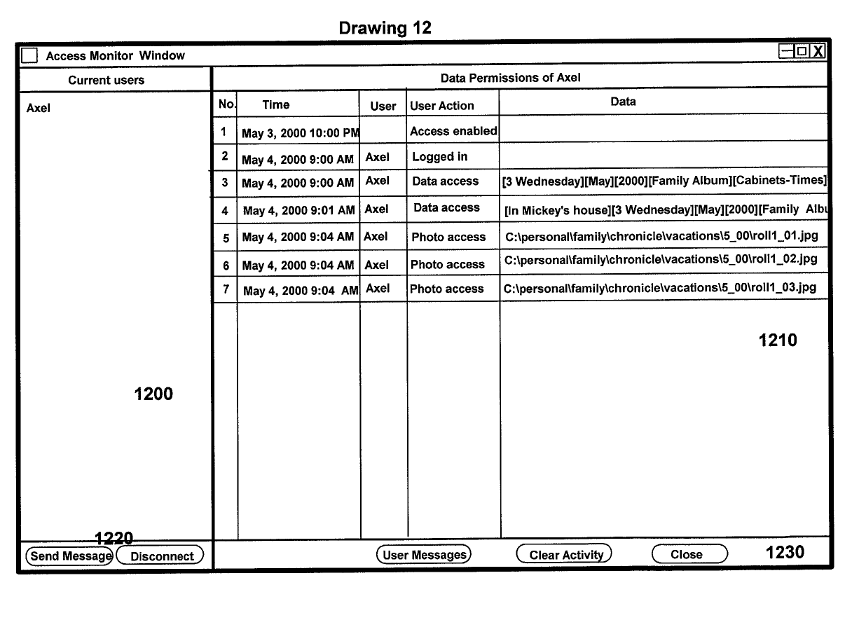

Each of the information items stored in the virtual file cabinet can comprise of graphical images, textual information and tabular information with references to multi-media files. All the information can be kept in one page or several pages. Selecting an item in the virtual cabinet displays the attributes of the item and also the contents of that item. All the contents of the virtual file cabinets can be viewed one-by-one or in a slide show manner sequenced using any of the specified attributes.

The virtual file cabinet can be made available to remote users using Internet without the need of any commercial third parties and the owner of the virtual file cabinet can grant permissions as to who can see what items and if the remote users are allowed to add any items to the virtual file cabinet. The activities of the remote users are logged and can be monitored in real time if desired.

### CROSS-REFERENCE TO RELATED APPLICATIONS

Not applicable.

### BACKGROUND OF THE INVENTION

1. Field of the Invention

The present invention relates to the field of composing, organizing and accessing information using multiple hierarchical categories with computer software.

2. Description of Related Art

This age is sometimes referred to as Information Age as there is an unprecedented amount of information being produced and consumed. Computers and a myriad of technical gadgets are responsible for this information explosion. So it is natural to turn to computers to address the needs of organizing and managing all this information. The present invention proposes a flexible way of organizing information using a computer software system so that it can be easily organized and easily accessed later on.

File cabinets are a well-known mechanism for organizing information. Typically, sheets of paper are filed into folders in the file cabinet and each folder has a nametag identifying the type of information placed into it. Using physical file cabinets and physical information like sheets of paper, the information item can be filed into one and only one older, even though the information on the sheet of paper has several attributes to it, like date and time, people involved, locations involved and several possible subjects it can be categorized under. Only one attribute of the information has to be chosen for filing it and the others are implicitly understood from the information content. Similarly while accessing the information, the information item can be accessed only by remembering the type of attribute used for filing it (the name tag on the folder). It cannot be accessed using any of its other attributes as these are not used for filing it.

It would be nice if the same information item can be placed into several folders, with each folder corresponding to one of its attributes, time, people, location, subjects, etc. If it is possible to file information items like that, then these can be accessed using any of their attributes, not just one attribute. This is not possible with physical information items, like sheets of paper in regular file cabinets. But it can be possible with information items stored in computers. The present invention addresses such needs by taking advantage of the fact that the information in computers does not have any physical constraints.

The utility of the present invention will be explained first using a photo album as an example. Then several other applications where this invention will prove to be similarly novel and advantageous will be described. The shortcomings of the present art with reference to these advantages will also be highlighted.

A photo album is like a file cabinet where all the contents are arranged in chronological order. The viewers of an album can view the photos in the order chosen by the creator of the album and this order cannot be changed. This is certainly true of the physical photo albums, which have physical pages and the photos are affixed to the pages in various ways.

Each photo in an album can be associated with a certain time, people or objects in the photo, location of the photo and subject matter of the photo (occasion or event, etc.) For example, the photos taken at Christmas time of every year can be categorized under Christmas category. If somebody wants to see all the photos taken at Christmas time in the past few years, he/she needs to turn back all the pages of a chronological album by a year at a time to see each set of Christmas photos. But if the album has been arranged subject-wise instead of chronologically, all the Christmas subject photos will be sequential!

Consider another example of a family that goes to Disneyland every year and keeps all the photos of their children enjoying the various rides in photo albums. If they want to see all the photos taken at Disneyland over the past few years, to see how the interests of their children changed over the years as they grew up, they have to wade through all the photos taken meanwhile just to get to the Disneyland photos. If the photos have been arranged location-wise, all the Disneyland photos over the years would be sequential!

Consider the example of someone who wants to see only the photos of his/her favorite person over the years. There is no way to access just those photos from an album. But if the photos have been arranged people-wise, all the photos of that person would be sequential!

Thus it is obvious that the photos can be arranged in any order depending on the information in the photos to suit the various types of needs. Chronological arrangement is utilizing the time attribute of the photo. A subject arrangement would utilize the subject information of the photo. A location arrangement would utilize the location information of the photo and a people arrangement would utilize the people information of the photo.

Because of the limitations of the physical media, only one arrangement is possible for physical photos in physical albums. But with digital photos and digital media, there are no physical limitations. But the digital albums currently available in the industry are just trying to mimic the physical album and not providing any novel features possible with the computer technology. Products based on U.S. Pat. No. 6,064,384 display an image of a physical photo album and flipping of pages. The present invention describes a software system in which with a single-click, the whole album can be transformed from a chronological album to a people-based album or a location-based album or subject-based album. With this invention, the viewers of an album are not restricted to viewing an album along just one category. All the photos in the album can be viewed sequentially in several categories.

The flexibility of viewing information sequentially in various categories can be useful to not just for photo albums, but for any collection of information. Consider the case of a personal dairy where a person enters his/her daily thoughts, memories and activities. If that person wants to reminisce all the memories related to one location, one person or one subject, it would be nice if that dairy entries can be arranged in the order of the interest.

This flexibility would be very useful for personal organizers in which people keep information relating to their appointments, business activities, meeting minutes, etc. With this type arrangement it would be very easy to see all the related tasks of, say of a project or an activity, from various points of view, people, subject categories, location, etc. If a business person organizes all the minutes of the business meetings he/she attends with the method proposed in this invention, then it would be very easy to see all the related meeting minutes according to any relevant category, one particular project or subject, one particular location or particular people. It would be as if all the meeting minutes are arranged in the desired order right from the beginning and all the entries can be seen in sequence either automatically or manually. This is more powerful and more useful than searching for a topic in the information collection and finding all the related pieces one by one.

This type of arrangement would be useful for organizing any information that has more than one attribute and all information does! So the flexible organization of information proposed by this invention can be used in various types of information storage applications, photo albums, dairies, personal information organizers, etc.

The use of hierarchical categories for filing information facilitates aggregating information at any desired level. Continuing the photo album example, with the use of hierarchical categories for location, all the photos taken in California can be accessed once and viewed sequentially. With hierarchical people categories all the photos of a group of people based on name or relation can be accessed once and viewed sequentially. Similarly from a hierarchical time category arrangement, all the photos of a day, month or year can be accessed. In a personal organizer where one keeps tracks of all the business meetings and their minutes, all the minutes of meetings over one subject or a group of subjects or with one person or a group of people can be aggregated at once and viewed sequentially.

It is not necessary that all the information associated with an information item placed in a photo album or a personal organizer is a file in the operating system. The files in the operating system are of homogeneous content of one specific format and only by opening them with an application one can see their content. In recent operating systems like Windows 2000 it is possible to see thumbnail images of graphical files and some attribute information of the files by simply selecting the file name without opening it. But in order to see any textual content or tabular content, some software application needs to be used. There is also no way to specify any type of relationship between files in a folder except that all of them share a common location (folder) in the file system. So, in a photo album example, if somebody wants to group a certain set of photos, say all the honeymoon photos and associate text description to each of the photos and also associate tabular type of information like all the details of the activities and places and keep references to other multi-media files like audio and video files and if it is desired to see all this information (and hear the audio files and view the video files) when the honeymoon item is selected, there is no way to do that using the files in a file system. So for the purposes of organizing digital photos and keeping some associated information with them or for organizer types of functionality storing that information in files is not convenient and useful.

The present invention proposes information items like the one described above which facilitate associating different types of information to an item and view it all at once or page-by-page without the need for opening individual applications for each type of information content. The content of an information item can be a collection of multiple images, multiple textual descriptions and multiple tabular data.

In the present art, when efficient ways of organizing information using computers are considered, the attempts focused on organizing the information in terms of operating system files. These attempts can be broadly categorized into two areas. First area focuses on improving the appearance and usage mode of file systems and second area focuses on improving and automating the way files are stored into folders. There have been attempts in the related art to introduce the file cabinet paradigm to storage of computer files. Some attempts (for example, U.S. Pat. No. 5,751,287) go to the extent of displaying a file cabinet and opening and closing of drawers, etc. These did not improve the filing process in terms of organizing and accessing beyond what can be done with their physical counterparts except for computerizing all the operations.

The second area of attempts focused on automatically organizing the information by inferring the category information from the content to decide which folder the file can be placed in (for example, U.S. Pat. No. 5,899,995). These make the task of organizing easier. But one thing common to all these attempts is that information is filed using only one category and the information item, the file, is present under only one category. These attempts did not take full advantage of the fact that information is not on physical items anymore, but it is inside the computers.

The present invention takes advantage of the fact that information is inside the computers and it is much more flexible in terms of organizing and accessing. It proposes a software system for organizing information items using multiple hierarchical categories. So it is as if the same information is present in several file cabinets each one using a different attribute for filing and the category folders have several levels of sub folders associated with them. The present art does not provide this type of flexibility in organizing the data. The present invention also introduces a new way of defining the content of an information item as a collection of multiple graphical images, textual and tabular data.

Now we will describe another aspect of related art, sharing of the stored information with others and describe how the present invention proposes a novel way for it. We will, once again, use the example of a photo album to explain it.

The products available currently in the software industry for sharing photos fall into these two categories:

Sharing of photos using a third party provided web server machine, i.e. the photos are uploaded to a computer system operated by a commercial company and all the people that want to see the photos access that company's machines using a browser application software, or

Transferring the photos to some other physical media, like CDs (compact discs) or zip drives and physically shipping those to the interested users.

The related art thus does not provide any way for sharing photos from a digital photo album set up by a user on his/her computer system without resorting to some external means. This invention proposes a system where the photos can reside in the computer system of the user who creates the album and can be viewed by anybody who is granted permission by the user without any external commercial parties or products. The owner of the album can define some user names and passwords and designate what can be viewed by each user. The users can login to the software system of the present invention and can access all the permitted data. There will be a log of all the activities performed by the users and the owner of the system can also monitor in real time all the activities performed on the album by the remote users, if desired. The owner can also permit some users to add to the collection of photos, thus encouraging all the interested parties to generate a common photo album. Thus information repositories can be built on one user's own computer system and shared by several users by accessing it directly without any commercial third parties.

In this way of sharing information proposed in the current invention, the owner of the system does not need to be operating the software when some remote users are accessing data from the system. The owner can simply enable remote access for the system and keep it running. The remote users can login into the system at their convenience. Thus the way of sharing information proposed in this invention differs from other types of sharing data between users where both the parties need to be present and operating the software.

This type of sharing of information while enforcing control and providing monitoring can be useful for different types of information organized with the software system presented in this invention. Personal organizers where people keep their schedules can be shared with their family and friends. The family and friends can know the availability of each other very easily with this software system and, if allowed, they can make some entries into each other's schedules to set up some get-togethers or dinners.

The present invention thus addresses the shortcomings in the prior art of not having any easy way for organizing and viewing of information in several categories and not having a way to share information right from out of one's computer system while enforcing permissions and monitoring activities.

### SUMMARY OF THE INVENTION

The present invention comprises of a software system in which users can create information collections in virtual “file cabinets”. The users can “file” information into the virtual “file cabinet” under various categories. In a physical file cabinet, the physical information, like sheets of papers, can be filed in only one category. But in this digital (virtual) filing cabinet, the information can be stored under several attributes like time (date and time), people involved, location involved and a primary and secondary subject. The virtual file cabinet serves as several file cabinets each one holding information categorized using one attribute, thus there can be a time cabinet, people cabinet, location cabinet, subject cabinet, etc.

The information items stored in the virtual file cabinet are not simple files stored in a computer. These information items can comprise of several graphical images, several textual descriptions, possibly is some markup languages like Hyper Text Markup Language (HTML) and tabular information. The textual and tabular information can have references to other multi-media files on the computer system. There can be several pages of this type of information.

When a user files an item of information using this system, the user enters information for all the desired categories and also defines the content of the item. Then the information item is generated and the same item is placed into as many cabinets (information collections) as the number of categories. The categories are alphabetically arranged in people, location, primary and secondary cabinets and chronologically arranged in the time cabinet. Depending on under which categorization the user wants to see the data, based on time, people, location or subject, the appropriate cabinet can be selected and all the information appears categorized using that attribute. When the information item is selected, its contents are displayed. The graphical images and the textual and tabular data are displayed. If there are any references to any audio or video files, the appropriate applications to present that information will be launched automatically, if the user has selected that option.

For facilitating storage of information under various categories, a hierarchical set of categories for people, locations and subjects can be created first. For example, the hierarchical categories for people can be family, friends and various groupings of people based on their last names. The hierarchical categories for locations can be as country, state, city and various locations in a city like home, park, beach, etc. The hierarchical categories for subjects can be like, vacations, beach vacations, skiing vacations, etc. Time categories are automatically defined by the system to be years, months and days and the item is categorized based on the time information entered by the user.

The items in each cabinet are arranged hierarchically in a ‘tree’ like fashion. In a time cabinet, the hierarchy is pre-defined to be years, months and days. In the other cabinets, the category hierarchy entered by the users is used. The users can see only one cabinet at a time. All the cabinets are arranged using tabs and each cabinet has a tab. Each cabinet can be selected by clicking on its tab. Thus the user can see the information in different sequential orders by a single click. The user had to enter the information for each item only once and that item appears in all the cabinets. Whatever further modifications are made to that item will also be reflected in all the cabinets.

The content of each information item is shown when that item is selected. If it is desired to see the information of all the items in the hierarchy starting from a particular level, this can be seen in a separate window of the application. The information of all the items can be seen by manually going through ‘page’ by ‘page’ or can be seen automatically in a slide-show manner. It is possible to see a multiple number of pages at the same time.

If the owner of the system would like to share thus arranged information collection with other computer users, it can be done using the Internet. The owner's computer and the other users' computers should be connected to the Internet and the users should know their Internet Protocol (IP) address. The owner of the system can specify login names and passwords and what information each user can view. The owner can also specify if the users can only view the information or if they can add some more information to the collection.

The owner of the system would set his system in a mode to enable remote users connecting to the system. Then the remote users would connect to the system by specifying the IP address of the system where the information collection is available. The remote users can login at anytime when the software system is running. The owner of the system does not need to be present when the remote users are connecting to the system. The remote users can see the information they are allowed to see, according to any of the categorizations (in any sequence, time-wise, people-wise, subject-wise, etc.). All the activities of the remote users are displayed in a separate window so that the owner of the system can monitor the activity, if desired, in real time as it is happening. All this activity is also logged into a log file.

The software system presented in this invention thus permits a flexible organization of multi-media information that can be accessed using any of the specified attributes of the information and allows keeping different types of multimedia information together as a single item. This also allows sharing of the information collection without depending on any commercial services.

### OBJECTS AND ADVANTAGES

Accordingly, several objects and advantages of the present invention are

1. All items in any information collection can be viewed sequentially using multiple attributes, not just one attribute facilitating, for example,

a. digital photo albums that can be viewed chronologically, or people-wise or location-wise or according to several subjects.

b. personal or business appointment calendars, where the entered appointments can be accessed using all the attributes with which those are defined.

2. The viewers of any information collection are not restricted to viewing the collection only in one fixed way.

3. The information content of any item stored in these information collections can be a collection of graphical images, textual and tabular data with references to other multi-media files. So it would be possible to develop rich photo albums providing details of all the photos and even attach some audio and video files. Any information collection, photo albums, personal organizers, can become a multi-media information collection.

4. The information collections developed by a user in this way can be easily shared with other users directly from the user's computer, using the internet, without needing any commercial web servers and without exporting the contents of the collection to any other server or to any other physical media.

5. The owner of the information collection can permit other users to add to the information collection. With this way, far flung families can jointly develop a family photo album or even family chronicles comprising of various of types of information.

Further objects and advantages of the present invention will become apparent from the consideration of the drawings and ensuing description.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, which show the user interface of the computer software that implements the concepts of the present invention, wherein:

Drawing 1 indicates the major areas of the user interface and an example set of people categories. The content of the selected people item “Bees” is shown. This content consists of 1 text frame, 4 photo frames and 1 table frame.

Drawing 2 illustrates an example set of location categories. The content of the selected location item “Disneyland” is shown. This content consists of 1 text frame.

Drawing 3 illustrates an example set of subject categories. The content of the selected subject item “Amusement park” is shown. This content consists of 1 text frame.

Drawing 4 illustrates a new information item being defined to be placed into a cabinet. The item is named ‘In Mickey's house’ and it is going to be filed into ‘Family Album’ cabinet. This item has 4 pages of information. First page, which is displayed, has 3 photo frames and 1 text frame.

Drawing 5 indicates how the information item ‘In Mickey's house’ is going to be entered into the time cabinet. The year, month and date form a natural hierarchy in this cabinet. Tab number 1 is selected to see the time cabinet.

Drawing 6 indicates how the information item ‘In Mickey's house’ is going to be entered into the people cabinet. The people category information entered for this item defines its hierarchy in this cabinet. Tab number 2 is selected to see the people cabinet.

Drawing 7 indicates how the information item ‘In Mickey's house’ is going to be entered into the location cabinet. The location category information entered for this item defines its hierarchy in this cabinet. Tab number 3 is selected to see the location cabinet.

Drawing 8 indicates how the information item ‘In Mickey's house’ is going to be entered into the primary subject cabinet. The primary subject category information entered for this item defines its hierarchy in this cabinet. Tab number 4 is selected to see the primary subject cabinet.

Drawing 9 indicates how the information item ‘In Mickey's house’ is going to be entered into the secondary subject cabinet. The secondary subject category information entered for this item defines its hierarchy in this cabinet. Tab number 5 is selected to see the secondary subject cabinet.

Drawing 10 illustrates the ‘Show Window’ for the item ‘In Mickey's house’ with a specified layout of 4 pages. All the 4 pages of this item can be seen at one time in this layout.

Drawing 11 illustrates specifying access permissions to the information items in information collections to remote users. The users can see only the data, which they are allowed to see. The permissions can be ‘Read only’ or Read and write’. This drawing shows granting Read only permission to a user named Axel to see the data of May 3, 2000 from time cabinet.

Drawing 12 illustrates monitoring of remote users' actions in real time as they are accessing the information items they are allowed to see. This drawing shows the actions of user Axel while logged in.

### REFERENCE NUMERALS IN DRAWINGS

### Drawing 1

100 The area where all the cabinets (information collections) are displayed.

110 The area where all the categories are displayed

120 The area where the meta-data of the information item is entered and displayed.

130 The area where the content of the information item is displayed

140 These are the tabs that decide which type of cabinet is being displayed. There are five tabs that correspond to five cabinets arranged according to time, people, location, primary subject and secondary subject. Selecting one of these tabs displays the corresponding cabinet with the items categorized according to selected attribute.

150 These are tabs that decide which type of categories are being displayed. There are three tabs corresponding to three types of categories, people, location and subjects.

160 The name field of the selected item

170 A textual frame containing the description of the selected item. The text can be in Hyper Text Markup Language (HTML) format.

180 Photo frame comprising of the content of the information item

190 A tabular data frame comprising of the content of the information item

### Drawing 4

400 The name field of the information item being defined

410 The priority field of the information item being defined. This can be used to denote the priority of an item, as Normal or High. This would be useful in personal or business organizers.

420 If the item is an appointment in future, the user can request that an alarm window be shown when the appointment time arrives. As a part of the alarm, an audio or video file can be specified. The specified file contents will be played back when the appointment time arrives.

430 Recurring appointments can be set up using this button

440 The date and time information of the item being defined is entered here.

450 The people category information of the item being defined is entered here. This information comes from the people category in the categories area.

460 The location category information of the item being defined is entered here. This information comes from the location category in the categories area.

470 The primary subject category information of the item being defined is entered here. This information comes from the subject category in the categories area.

480 The secondary subject category information of the item being defined is entered here. This information comes from the subject category in the categories area.

490 These are tabs that show the pages in the content of the information Item. Selecting a tab would display the corresponding categories Hierarchy.

### Drawing 5

500 The time cabinet entry of the defined item, ‘In Mickey's house’.

### Drawing 6

600 The people cabinet entry of the defined item, ‘In Mickey's house’.

### Drawing 7

700 The location cabinet entry of the defined item, ‘In Mickey's house’.

### Drawing 8

800 The primary subject cabinet entry of the defined item, ‘In Mickey's house’.

### Drawing 9

900 The secondary subject cabinet entry of the defined item, ‘In Mickey's house’.

### Drawing 10

1000 The layout of the window is specified here, as 1×1, 2×2, 3×3 or 4×4 which shows 1, 4, 9 or 16 photos respectively.

1010 The time interval between pages in auto-scroll mode is specified here.

1020 These are the controls to go through all the items being displayed in Show window.

1030 Page 2 of the selected information item

1040 Page 3 of the selected information item

1050 Page 4 of the selected information item

1070 The progress bar indicating how many pages out of the total pages are already displayed.

### Drawing 11

1100 The area where the remote users' login names are displayed.

1110 The area where the data the selected remote user can access is displayed.

1120 The area where there are buttons to issue commands to add a remote user, edit remote user's data permissions and delete a remote user.

1130 The area where there are buttons to add data that can be accessed by the selected remote user and to delete the accessible data. There are buttons to save the entered information and to close the window.

### Drawing 12

1200 The area where the login names of the currently logged in users are displayed.

1210 The area where the activities of the users are displayed. The time of the action, the name of the user, the type of action and the data of the action are displayed.

1220 The area where there are buttons to issue commands to send messages to currently connected users and to disconnect them, if necessary.

1230 The area where there are buttons to issue commands to see all the messages sent by remote users, to clear all the activity entries and to close the monitor window.

### DETAILED DESCRIPTION OF THE INVENTION

The concepts described in the present invention have been implemented to produce a working software system and this system can be installed on any personal computer. A detailed description of the implementation is provided here.

The software is implemented using Java language. The user interface is developed with Java Foundation Classes (swingset). The implementation uses JTree class of swingset for implementing the hierarchical trees. Java Imaging package is used for handling photos. (Java class names are shown in Courier font).

The user interface of the system is described first and then a description of how somebody can use the system is explained. Only the novel features of the present invention are explained in detail. The features of the system that are common to most of the personal computer software are not elaborated in detail.

### User Interface

The user interface of this system is similar to the user interfaces of several programs that are available for personal computers. This user interface is shown in Drawing 1. This has a menu bar at the top and a tool bar below that with a subset of the commands available from the menus.

The area under the tool bar is divided into two regions. The left and right regions are again divided into two regions. These regions are labeled as 100, 110, 120 and 130 in Drawing 1. The description of these areas is as follows:

100—Cabinets area: This is where the information collections (cabinets) and the information items in the collections are displayed in hierarchical trees.

110—Categories area: This is where the category hierarchies used for categorization of the information items are displayed. These are also displayed as hierarchical trees.

120—Data Definition area: This is where the meta-data about the information item in the cabinet is specified and displayed.

130—Data Content area: This is where the data content of the information item is specified and displayed.

In the Cabinets area, there are tabs (140) for displaying the five types of cabinets (information collections). The five types of cabinets are as follows:

Time cabinet: All the items will be ordered according to the date and time. This cabinet always exists. All the other cabinets are optional.

People cabinet: This cabinet can be used to organize information based on people categories.

Location cabinet: This cabinet can be used to organize information based on location categories.

Primary subject cabinet: This cabinet can be used to organize information based on a category from the subject categories.

Secondary subject cabinet: This cabinet can also be used to organize information based on a category from the subject categories.

In the Categories area, there are tabs (150) for displaying three types of categories. These are as follows:

People categories: These categories provide classification and information on people.

Location categories: These categories provide classification and information on locations.

Subject categories: These categories provide classification and information on various subjects.

In the Data Definition area (120), the meta-data information about the item is entered whiled defining the item. This information is displayed in this area, when an item is selected.

The Data Content area (130) contains the data of the item placed in the cabinet. The data can be textual data in a text frame, or a tabular data in a table or a photo in a photo frame. There can be any number of frames of any of these three types in this area. This area can have multiple pages in the form of tabs. So the content of a data item can have multiple pages and each page can contain any number of frames. The size of the frames varies automatically depending on the size of the main window. The data entered in the text frame or table frame can be the names of multi-media files, audio, video or graphical files. By selecting the name of the file and issuing ‘open’ command will launch the multi-media file with the appropriate application. Or the user can specify an option to open all the multi-media files automatically whenever the item is selected.

### Organizing Information

Now let us consider how somebody can develop a family photo album that can be viewed along several categories and how it can be shared with several people. As an example, let us describe how the Bee family, which consists of Max and Pam and their two children Vic and Sue, can develop a photo album to store the photos of their Disneyland trip. With each step, the operations done internally by the software are also explained at a level enough for a software engineer familiar with Java language to understand the mechanism.

1. The categories with which the photos will be classified need to be created first. From the File menu (or from the tool bar), the command to create a new category file can be selected. The name of the category file, where it should be placed in the file system of the computer and the attributes of the category file, whether it should hold all three types of categories or not, can be defined. The categories are named ‘Personal’ as shown in Drawing 1. This command creates a file in the specified location in the operating system.

If all the three types of categories are specified for this category file, then three tree objects of type JTree are created and placed under each of the tabs in a tabbed pane, which is of type JTabbedPane.

2. The information for each of the categories can be defined next. For people categories, the categories can be family and friends and these can be further classified. The categories and sub-categories are defined using commands from the menu bar or tool bar. The command to create a new item allows item meta data to be entered in Area 120 and item content in area 130. Using again menu or tool bar, photo frames, text frames or table frames can be created to define the information item.

After defining the item information, clicking on Accept Data button in Area 130 creates the new item. A new node is created and placed in the tree in alphabetically sorted location. The node is of type DefaultMutableTreeNode. The node has a user object and the user object holds all the information about the item.

An example hierarchy of people categories is shown in Drawing 1. The Bee family entered information about themselves, Pam and Max, the parents and their son Vic and daughter Sue. They entered information about their friends, the Axels, also. The Bee family information consists of 1 text frame (170), 4 photo frames (180) and 1 table frame(190). All these frames are objects of type JInternalFrame and these are inside a JDesktopPane object. The text frame contains an editor pane of type JEditorPane and this pane has an editor kit of type HTMLEditorKit. The photo frame contains a label of type JLabel that is created using the image of type PlanarImage that is obtained from the specified digital photo file. The table frame contains a JTable object.

3. For location categories, the geographical information can be defined as a hierarchy. Drawing 2 illustrates an example set of location categories.

4. Subject categories define the subject information as a hierarchy. An example set of subject categories is shown in Drawing 3.

5. A cabinet file to hold all information collection can be created next using the menu bar or tool bar. This cabinet file will serve as a photo album in the case of somebody storing photos into the cabinet. The cabinet file name and what types of cabinets will be used in this file (all 5 types or only some of those) can be specified. Once the cabinet is created, items can be placed into it. The cabinet is called Family Album as shown in Drawing 3.

Cabinets are also implemented using JTree class. If all the 5 types of cabinets are specified, 5 trees are created and placed in the tabbed pane.

6. The command for creating a new data item allows information entry into the Data Definition area. Drawing 4 shows the data definition area in detail. The fields where data can be defined are as follows:

400—The name of the item can be entered into the name field.

410—For applications where this system is used an appointment calendar, the priority of the item, normal or high, can be selected.

420—For applications like appointment calendars, an alarm can be set to remind the user when this appointment time has come.

430—Recurring appointments can be created with recurring item command.

440—The time of the item can be entered in the date and time fields. For time, an end time can also be entered if desired.

450—The people category of the item is entered in this field, if a people cabinet is defined for this cabinet file.

460—The location category of the item is entered in this field, if a location cabinet is defined for this cabinet file.

470—The primary subject category of the item is entered in this field, if a primary cabinet is defined for this cabinet file.

480—The secondary subject category of the item is entered in this field, if a secondary cabinet is defined for this cabinet file.

For the current album example, the fields 410, 420 and 430 need not be filled and the categories defined earlier in steps 2, 3 and 4 can be used to fill the fields 450, 460, 470 and 480.

For this example, let us consider how the Bee family would organize the photos they took in Disneyland when they went there on May 3, 2000 to celebrate their son's birthday. Drawing 4 illustrates defining an item named ‘In Mickey's house’. The date and time are entered as May 3, 2000 at 10:00 AM. The data for people category is entered as the hierarchical category [Personal] [Family] [Bees] [Vic] as these are photos of Vic. The Location category is entered as Disneyland with the appropriate hierarchical path. Amusement Park vacation is specified as a primary subject category and birthday event as a secondary category.

7. Once the meta-data of an item is defined, the data content of the item can be defined next. A photo frame can be defined by a command from the menu bar or tool bar. Then a window will pop-up for entering the photo file information. In this window, one or several photo files can be chosen from the file system of the computer. A title for the photo(s) can be specified. If multiple photos are selected, their layout (how many photos in each page) can be specified. Then the system will read the photo information from the specified files and displays them in the Data Content area. Multiple pages will be created if needed.

As mentioned earlier, a PlanarImage object is obtained by loading the image file using Java Imaging package functionality. A JLabel is constructed with the image and placed in the JInternalFrame created for the photo frame.

A listener object is placed to listen for resizing events of the photo frame. Whenever the photo frame size changed, the listener object is invoked and the photo image is resized to fit into the newly resized frame. So the photos are always at the maximum possible size to fit into the frame.

8. The users can create a text frame on the same page or a different page to provide a description of the photos if desired. The textual description can have references to any multi-media files (audio, video, etc.) on the computer system. When the users are reading this information, the multi-media files can be opened and heard or seen.

A JlnternalFrame is created for the text frame and a JEditorPane and HTMLEditorKit are created to enable entering of text into the frame.

9. The users can also create a table frame to store any relevant tabular data if desired. The table can hold information about any related files, audio, video or any type of file. The related files can be specified to be opened automatically when this item is being viewed. Drawing 4 shows three photo frames and one text frame. The sizes and locations of the frames can be adjusted after defining them. If there is more content to be associated with this information item, more pages can be created. JTabbedPane class is used here also to create and depict different information pages (490). Each of these pages can have different layouts and different types of information.

10. Once the item is defined, it is placed in all the cabinets in the appropriate category hierarchy. By selecting the cabinet tabs, the same item can be seen sequenced along the five categories. Drawings 5, 6, 7, 8 and 9 show the views of the time cabinet, people cabinet, location cabinet, primary subject cabinet and secondary subject cabinet for the example item named ‘In Mickey's house’.

A user object is constructed which holds the data for the tree nodes. Then a node (of type DefaultMutableTreeNode) for each tree is created using this user object. The nodes are named the same name in all the cabinets, but their hierarchy differs. Different tree node objects are created for each cabinet tree. But all the different node objects have only one common user object, which holds the data of the information item. So any modifications done to the item in one cabinet are automatically reflected in all the cabinet trees.

Several information items can be defined in the same fashion to make an information collection, an album in this case. All the items will be placed into the cabinet trees at appropriate locations based on the values of their attributes.

11. By selecting the item in the cabinet, the content of the item appears in the Data Content area. If there are any references to any multi-media files in the table frame, the user can set an option to view those files automatically with the appropriate applications. All the items in a cabinet can be seen in a slide-show manner by selecting the show command from the menu or tool bar. Then a show window appears. Drawing 10 illustrates the show window and the information that can be specified to control the slide show. Number of pages to be shown at once (1, 4, 9 or 16 in layouts of 1×1, 2×2, 3×3 or 4×4) can be specified with the Layout option. The time interval between pages in auto-play mode can be set in the Interval field. Rest of the controls provides functionality to go through all the pages one by one or in an auto-play mode. Drawing 10 illustrates seeing all the 4 pages of information for the item ‘In Mickey's house’.

The Timer class of JFC is used to advance the pages automatically after the specified interval in auto-play mode.

12. The users can select the type of album, time based, people based, location based or subject based and can see all the photos in that type of sequence by selecting the appropriate cabinet. Any subset of the items entered can be seen by selecting the appropriate category.

The above 12 steps described how the present invention can be used to create a hierarchical multi-media information collection and view it sequenced along multiple categories at different granularity levels. Those steps also described how to specify different types of information for an item. Next we will describe how this information collection can be made available to other users using the Internet and how the other users can also add items to this information collection.

### Sharing Information

The information organized into digital file cabinets using the software system proposed in this invention can be shared with other users directly from one's own computer where the information is present. Let us consider how the Bee family would share their Disneyland vacation photos with their friends, the Axels.

1. The owner of the information collection can define which users can access this collection by defining login names and passwords. All the user information can be defined from the Access Control window (Drawing 11), which is displayed by selecting Access Control command from the menu bar. For each user, a set of data that user can see can be defined. This data can be selected from the cabinets. Then for each data item, its permission level, whether it is read only or read-write can be defined.

Drawing 11 illustrates granting permission to login name Axel to see the data of May 3, 2000 from time cabinet. Data from any of the cabinets, at any of the hierarchical subset levels can be made available for viewing. In this case the user Axel can see all the data that has a time attribute of May 3, 2000. The class JList is used to implement the list of login names and JTable is used to display the allowed data.

2. The owner of the system can inform the other users their login name and password and the Internet Protocol (IP) address of the computer that has the information collection.

The remote user can initiate a connection from his/her software system to another system by specifying the IP address, login name and password.

3. The owner of the present software system can start the software application and enable ‘share’ mode by a command from the menu bar. Now the system is ready for access by other users. An Access Monitor window (Drawing 12) is displayed to indicate all the remote users' activities. A log file is also created which stores all these activities. So the owner of the system can monitor all the remote users' activities in real time if desired.

Java Remote Method Invocation (RMI) is used for client-server communications. When the software system is placed in share mode, it starts RMI registry and starts the RMI server. So remote users can connect to this server now. A log file is started to store all the users' activities.

Drawing 12 shows the access monitor window. It shows the activity right from when the software system is placed in remote access enabled mode. Note that the first entry shows that the Bee family enabled remote access at 10:00 PM on May 3, 2000.

4. The other users can access this system from their computers, which are on the Internet. They can start the software application and select the command to connect to the remote system. They need to enter the IP address of the system to which they are connecting to and their login name and password.

As soon as the remote user is logged in, the server system checks for the accuracy of the login name and password. If the login name and password are correct, then the information the logged in user is allowed to access is sent to the remote user's software system. This information is displayed just like it is visible in the server software system. All the information is shown in the same organization as it is organized in the server system.

5. Once they are connected, they can see all the data they are permitted to see. They can access the data from different cabinets; they can start a show window and see the data in a slide-show manner.

Drawing 12 shows some activities of the user Axel. Note that Axel logged in at 9 AM in morning the next day. The other rows show the user Axel accessing all the photos from the first page of the ‘In Mickey's house’ information item. All this information is stored into a log file also.

6. If the remote user is permitted to add data, then he/she can place new items into the cabinet. These will be stored on the remote system where all the data is originally entered.

7. While the remote user is connected, the owner of the system can send a message to the remote user using the Send Message button in area 1220 in Drawing 12. There is also a button to disconnect a connected user if so desired.

The above steps described how the present invention can be used to share the information collection (photo albums, dairies, personal organizers, etc.) with several people and how several people can collectively develop a shared information collection, without the need for any commercial parties.

While this invention has been described with reference to one possible embodiment, this description is not intended to be construed in a limiting sense. Various modifications of the illustrated embodiment, as well as other embodiments of the invention, which are apparent to persons skilled in the art to which the invention pertains are deemed to lie within the spirit and scope of the invention.

What is claimed is:

1. A method of organizing a plurality of information items into a plurality of information collections in such a way that
a. providing a specification means for each said information item to define it with a plurality of attributes of hierarchical category information,
b. providing a categorization means for each said information item in as many said information collections as there are number of said attributes by placing each said information item in an appropriate hierarchical location in a sequential order according to said attributes in said information collections with the references in all said locations pointing to one address of computer memory storage for the content of said information item,
c. providing a selection means to view said information items in a sequential order according to any of said attributes in said information collections,
d. providing an aggregation means to select and view any hierarchical subset of said information items in any of said information collections,
whereby, information collections like photo albums, personal and business organizers, personal dairies can contain information items with several attributes and these information collections can be viewed sequentially according to any of the attributes of the information items, and
whereby, any subset of the information collection can be viewed by selecting a hierarchy level.

2. A method of specifying the content of an information item in such a way that
a. providing a composition means for said information item so that it can comprise of several graphical images, several textual descriptions with mark-up languages and several tabular descriptions with the latter two types referring to other multi-media items,
b. providing an arrangement means to keep said content in one or more pages,
c. providing a conveyance means for said types of said content said information item comprises of to a user, without any additional intervention or action by said user, when said information item is selected,
d. providing a means for viewing multiple pages of said content at the same time in a manual or automatically scrolled fashion,
whereby, information collections like digital photo albums can be prepared with items comprising of several related photos, descriptions of photos and any other multi-media information as a single unit of information.

3. A method of sharing information collections consisting of a plurality of information items with remote users
a. providing access control means by specifying which said remote users can access which subset of said information collection,
b. providing authoring means to said remote users to add new information items to said information collection by marking said information collection as writable and
c. providing monitoring means to see in real time all the activities of said remote users,
d. providing communication means to communicate with remote users by sending and receiving messages,
e. providing control means to terminate said remote user's access to the information collection by sending a disconnect message,
whereby, information collections like digital photo albums, or organizers can be made available to a lot of interested people while controlling and monitoring their access.
